(19) United States
(12) Patent Application Publication
(10) Pub. No.: US 2013/0055761 A1
(43) Pub. Date: Mar. 7, 2013

(54) JEWELRY PIECE WITH DETACHABLE PERSONAL PROTECTION BATON

(71) Applicants: Lauren Alford, Cape Girardeau, MO (US); John R. Buse, Houston, MO (US)

(72) Inventors: Lauren Alford, Cape Girardeau, MO (US); John R. Buse, Houston, MO (US)

(73) Assignee: LOXX, LLC, Cape Girardeau, MO (US)

(21) Appl. No.: 13/597,441

(22) Filed: Aug. 29, 2012

Related U.S. Application Data
(60) Provisional application No. 61/530,136, filed on Sep. 1, 2011.

(51) Int. Cl. F15B 15/02; A44C 5/02

(52) U.S. Cl. 63/4; 463/47.7

(57) ABSTRACT

A piece of jewelry is provided having a chain and a cap attached to the chain. A base is joined to the cap. A plurality of extensions are positioned within the base and nested within one another. An inner most extension is removably joined to the cap so that cap secures the inner most extension while the plurality of extensions telescopically extend when pulled away from the cap. The inner most extension detaches from the cap when the plurality of extensions are fully extended.

### CROSS-REFERENCE TO RELATED APPLICATIONS

This application claims priority from U.S. Provisional Patent Application No. 61/530136 filed Sep. 1, 2011 and having the title “JEWELRY PIECE WITH DETACHABLE PERSONAL PROTECTION BATON”, which is herein incorporated in its entirety.

### STATEMENT REGARDING FEDERALLY SPONSORED RESEARCH

Not Applicable.

### APPENDIX

Not Applicable.

### BACKGROUND OF THE INVENTION

1. Field of the Invention

The present invention relates to a piece of jewelry that contains a detachable protection device, such as a detachable personal protection baton.

2. Related Art

Protection devices are most often produced and bought to protect the user and others from various forms of harm, including but not limited to, sexual assault, robbery, physical bodily harm, and kidnapping. Protection devices are often kept in a person's automobile, purse, bag, or pocket. Therefore, most protection devices are not quickly accessible in the event of an emergency, such as sexual assault, robbery, physical bodily harm, and kidnapping. Another problem with current protection devices is they are often not carried in one's hand because many consumers fear they will be perceived as paranoid if they carry their protection device in their hand. Thus, the device is not easily accessible.

Furthermore, many consumers rarely take proper precautions on a daily basis against various forms of harm due to the unpleasing appearance of many protection devices. Accordingly, the device is not carried in one's hand or close to one's person and thus, is not easily accessible.

### SUMMARY OF THE INVENTION

In accordance with the present invention, the jewelry will have a detachable personal protection device to allow individuals to protect themselves from various forms of harm. The jewelry is pleasing to the eye and does not resemble any other type of protection device. It will be worn as normal jewelry and thus will be easily accessible to the user.

In one embodiment, a baton for use with a piece of jewelry is provided having a cap attached to the piece of jewelry and a base joined to the cap. A plurality of extensions are positioned within the base and nested within one another. An inner most extension is removably joined to the cap so that when the base is removed from the cap the plurality of extensions telescopically extend from the base.

In another embodiment, a baton for use with a piece of jewelry is provided having a cap attached to the piece of jewelry. A plurality of extensions are nested within one another. An inner most extension is removably joined to the cap so that cap secures the inner most extension while the plurality of extensions telescopically extend when pulled away from the cap. The inner most extension detaches from the cap when the plurality of extensions are fully extended.

In another embodiment, a piece of jewelry is provided having a chain and a cap attached to the chain. A base is joined to the cap. A plurality of extensions are positioned within the base and nested within one another. An inner most extension is removably joined to the cap so that cap secures the inner most extension while the plurality of extensions telescopically extend when pulled away from the cap. The inner most extension detaches from the cap when the plurality of extensions are fully extended.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a front schematic view of a piece of jewelry having a baton formed in accordance with an embodiment.

FIG. 2 is a front schematic view of the baton shown in FIG. 1 extended to be used as a self-defense device.

FIG. 3 is a front schematic and a cross-sectional view of a baton base formed in accordance with an embodiment.

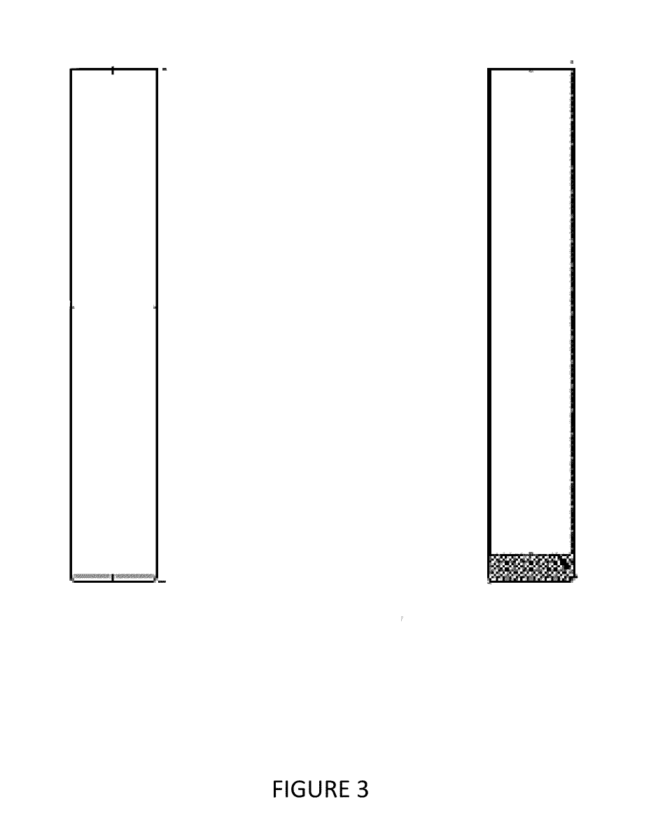

FIG. 4 is a front schematic and a cross-sectional view of a bottom extension formed in accordance with an embodiment.

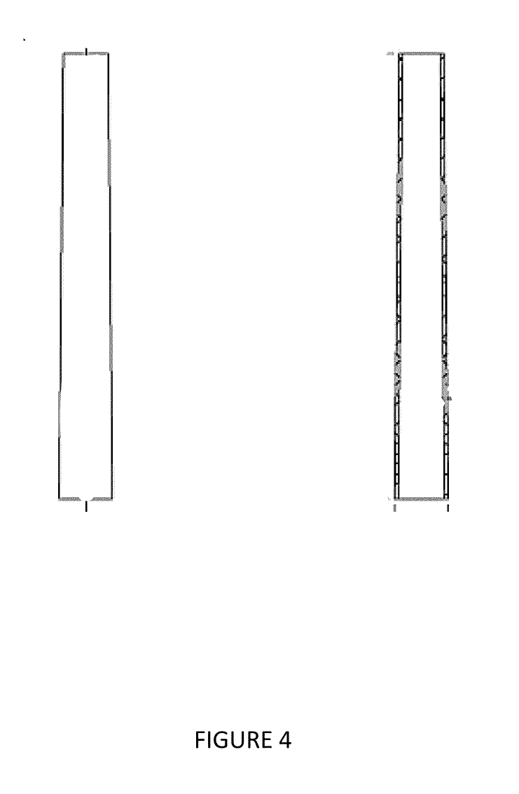

FIG. 5 is a front schematic and a cross-sectional view of an intermediate extension formed in accordance with an embodiment.

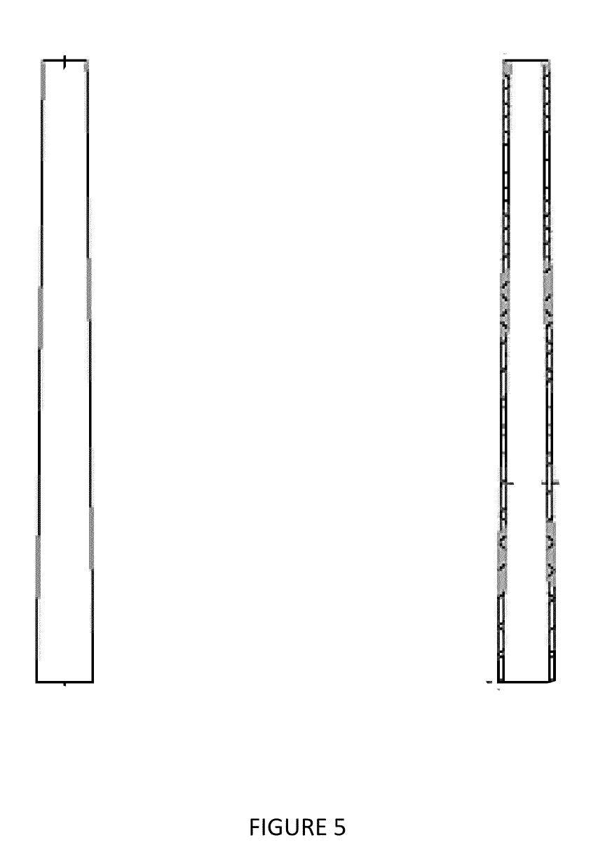

FIG. 6 is a front schematic and a cross-sectional view of a top extension formed in accordance with an embodiment.

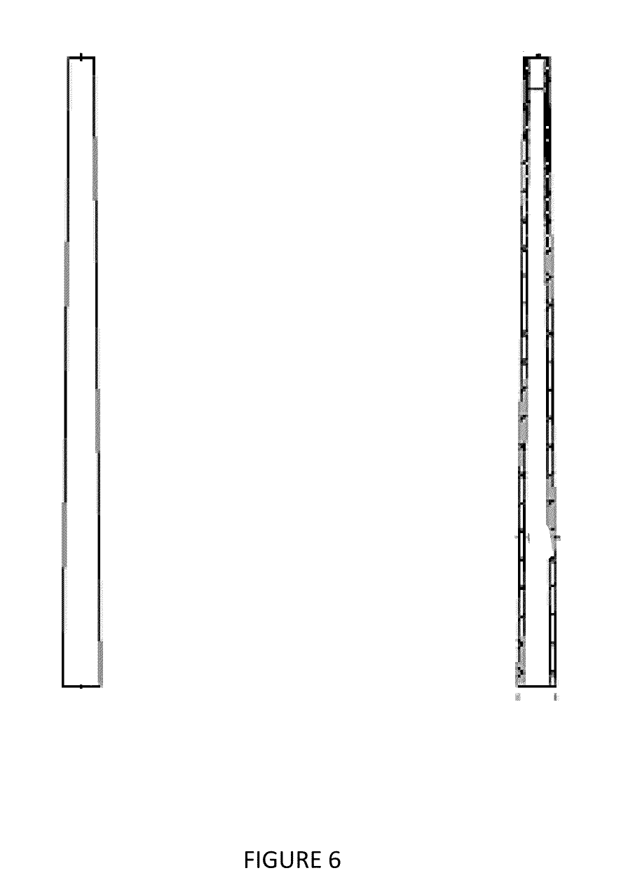

FIG. 7 is a front schematic and a cross-sectional view of a base end formed in accordance with an embodiment.

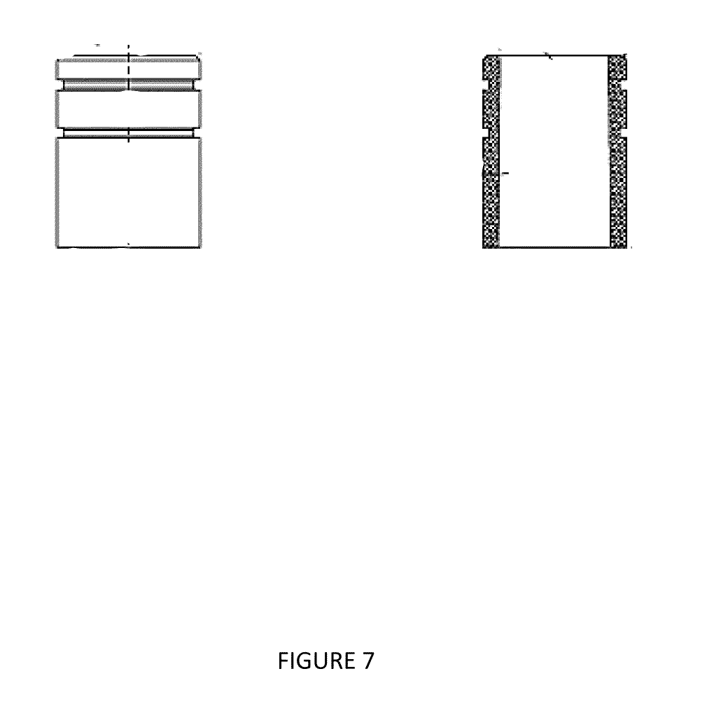

FIG. 8 is a top perspective view of an O-ring formed in accordance with an embodiment.

FIG. 9 is a top perspective view of an end piece formed in accordance with an embodiment.

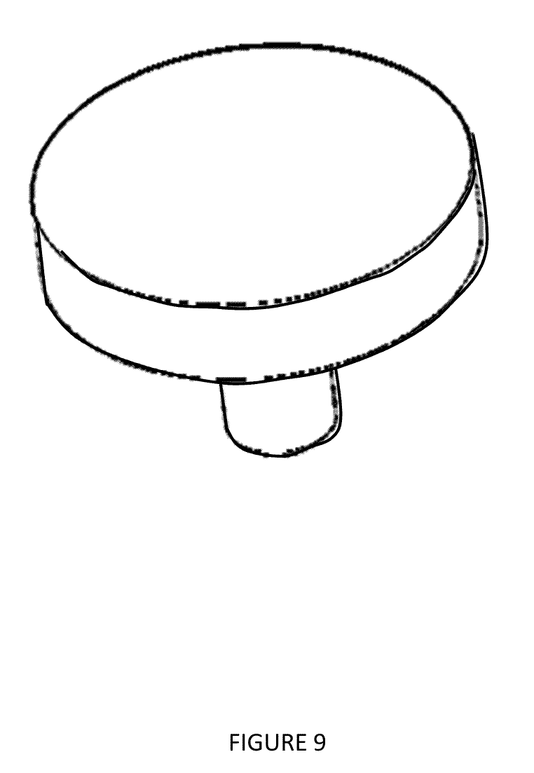

FIG. 10 is a front schematic and a cross-sectional view of a cap formed in accordance with an embodiment.

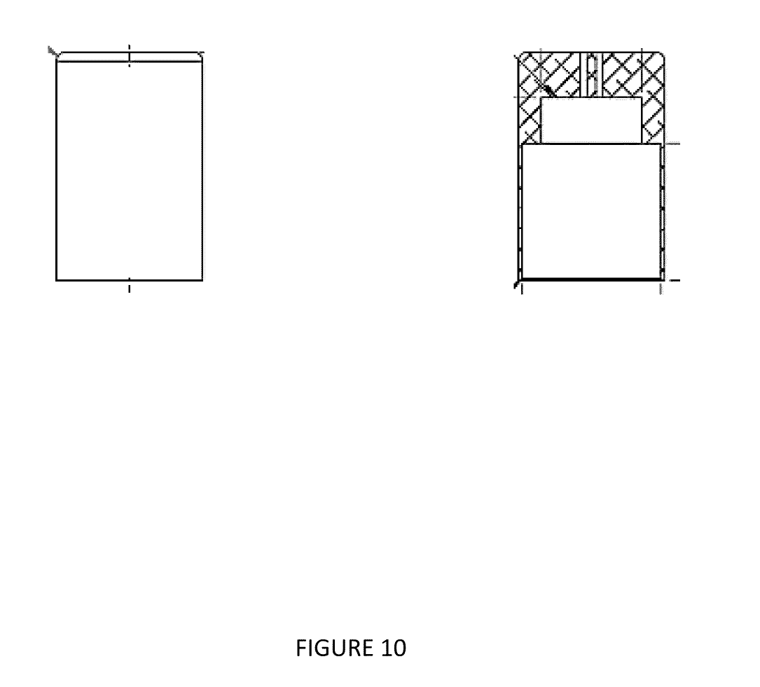

FIG. 11 is a top perspective view of a magnet formed in accordance with an embodiment.

FIG. 12 is a front schematic view of a hook formed in accordance with an embodiment.

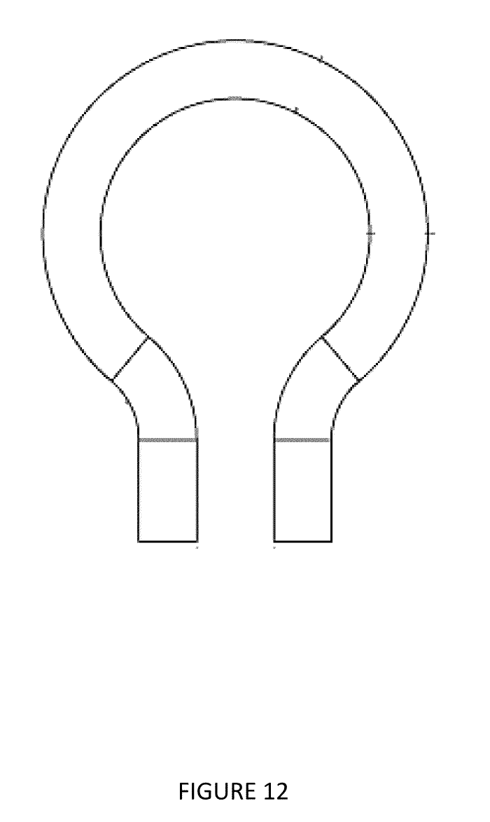

FIG. 13 is a front schematic and a cross-sectional view of a cap assembly formed in accordance with an embodiment.

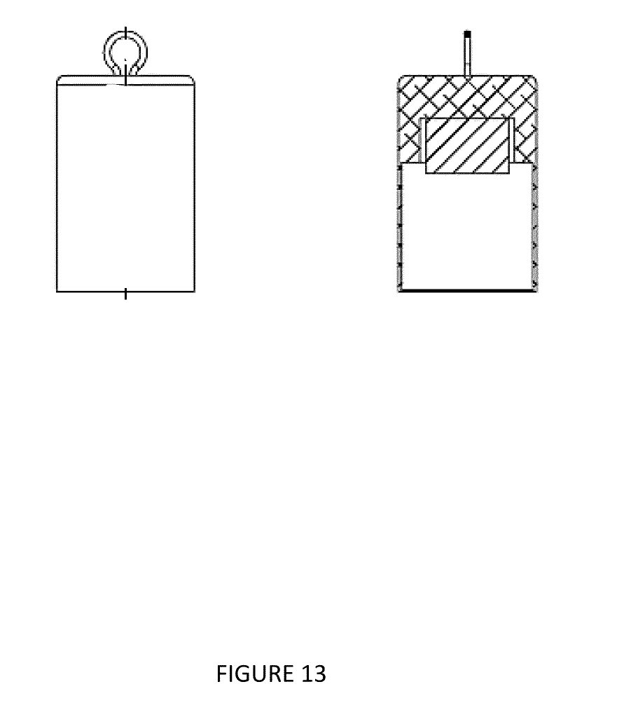

FIG. 14 is an exploded view of the baton shown in FIG. 1.

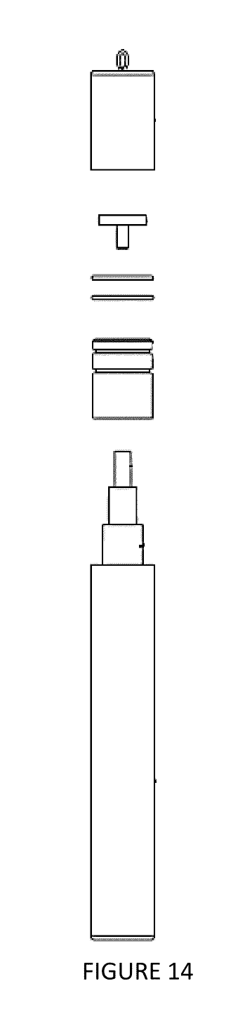

FIG. 15 is a cross-sectional view of the baton shown in FIG. 1.

### DETAILED DESCRIPTION OF THE PREFERRED EMBODIMENTS

The following description of the preferred embodiment(s) is merely exemplary in nature and is in no way intended to limit the invention, its application, or uses. It should be noted that the dimensions provided herein are exemplary only and the present invention may be scaled to any size.

The present invention is a piece of jewelry having a baton attached thereto. The jewelry includes a chain to which the baton is attached. The baton includes a cap attached to the chain and a base joined to the cap. A plurality of extensions are positioned within the base and nested within one another. An inner most extension is removably joined to the cap so that cap secures the inner most extension while the plurality of extensions telescopically extend when pulled away from the cap. The inner most extension detaches from the cap when the plurality of extensions are fully extended. In one embodiment the inner most extension is removably joined to the cap by a magnet. The baton may include an end piece secured to a top of the inner most extension, wherein the end piece is removably joined to the magnet positioned within the cap. Each extension tapers inward from a bottom to a top. A bottom of each extension has an outside diameter that is greater than an inside diameter of the top of the next adjacent extension positioned radially outward. Moreover, a base end may be joined to the top of the base. The base end has an opening with a diameter that is less than a diameter of the bottom of the outer most extension. The extensions are configured to extend through the base end when the plurality of extensions are extended.

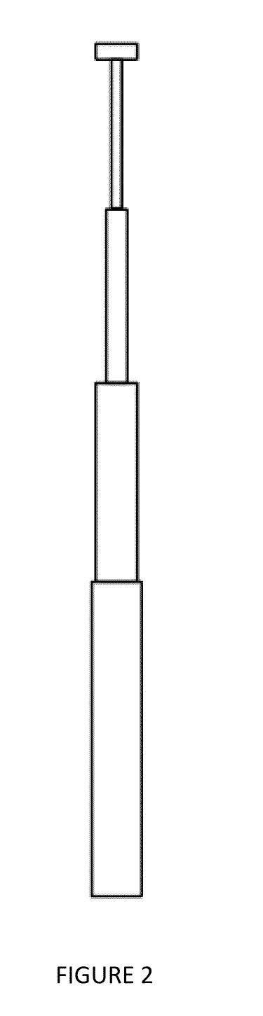

The baton has a hard outer surface, made of a material such as steel, sterling silver, or the like; however other materials may also be satisfactory. The components of the baton may also be formed from a material such as steel, sterling silver, or the like; however other materials may also be satisfactory. The baton may be telescopically extended, as shown in FIG. 2, and used for striking an attacker or otherwise protecting oneself. Alternatively, the baton may be used to strike an attacker without being extended. The chain is configured to be worn around a user's neck. In the illustrated embodiment the chain is configured to be decorative and may include designs, jewels or the like. The chain may be formed from steel, sterling silver, or any other suitable material. In one embodiment, the chain may also be usable as a restraint against attackers. For example, the chain may be easily removed from the user's neck, i.e. by pulling the chain so that chain separates at a separation point, and then used to restrain an attacker. It should be noted that the baton also may be attached to a bracelet or any other suitable form of jewelry. Moreover, the outer surface of the baton may be decorated so as to conceal the baton as being ordinary jewelry.

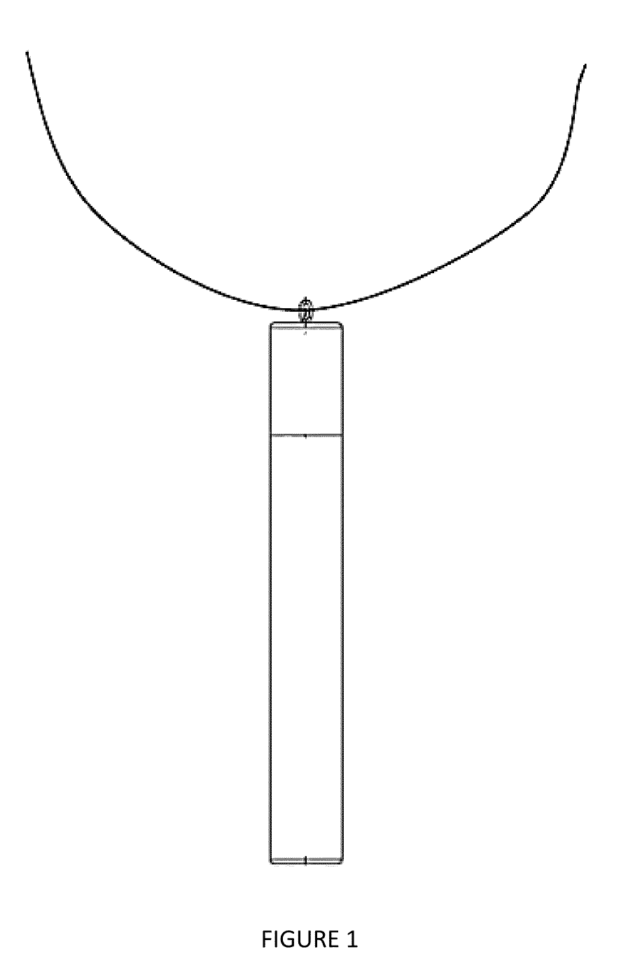

The cap of the baton is secured to the chain and the base of the baton is removably coupled to the cap with the extensions nested therein when the jewelry is worn, as shown in FIG. 1. To use the baton as a self-defense device, the user pulls downward on the base of the baton to separate the base from the cap, which is supported by the user's neck. The inner most extension is removably attached to the cap so that, as the base of the baton is pulled downward, the nested extensions telescopically extend to form an elongated baton. Once the extensions are fully extended, an additional force detaches the inner most extension from the cap, thereby providing a baton, as shown in FIG. 2, that may be used to strike an attacker.

The base of the baton is a hollow cylinder having an open end and a closed end. Optionally, the base may have any hollow shape including an open top and a closed bottom. In one embodiment, the base has a diameter of approximately 16 mm and a length of approximately 95 mm between the open top and the closed bottom. The base forms a cavity in which the extensions of the baton are nested when the baton is closed. The cavity has a diameter of between approximately 14.9 mm and approximately 15.1 mm and extends a length of approximately 90 mm from the open end to the closed bottom. The closed bottom includes a flat surface at the bottom of the cavity. The flat surface enables each of the extensions to nest thereon.

The outer most extension is sized to be received within the cavity of the base. The outer most extension is tapered inward from the bottom to the top. The outer most extension has an outside diameter of approximately 12 mm at the bottom and tapers inward to an outside diameter of approximately 10 mm at the top. The outer most extension has a thickness of approximately 0.8 mm. As such, the inside diameter of the top of the outer most extension is approximately 8.4 mm. In an exemplary embodiment, the outer most extension has a length of approximately 100 mm. Accordingly, when positioned within the base, the outer most extension extends outward from the open top of the base. The outer most extension is hollow to receive an intermediate extension.

The intermediate extension is sized to be received within the outer most extension. The intermediate extension is tapered inward from the bottom to the top. The intermediate extension has an outside diameter of approximately 9 mm at the bottom and tapers inward to an outside diameter of approximately 7 mm at the top. Accordingly, the outside diameter (9 mm) of the bottom of the intermediate extension is greater than the inside diameter (8.4 mm) of the top of the outer most extension. The intermediate extension has a thickness of approximately 0.8 mm. As such, the inside diameter of the top of the intermediate extension is approximately 5.4 mm. In an exemplary embodiment, the intermediate extension has a length of approximately 100 mm. The intermediate extension is hollow to receive an inner most extension.

The inner most extension is sized to be received within the intermediate extension. The inner most extension is tapered inward from the bottom to the top. The inner most extension has an outside diameter of approximately 6 mm at the bottom and tapers inward to an outside diameter of approximately 4 mm at the top. Accordingly, the outside diameter (6 mm) of the bottom of the inner most extension is greater than the inside diameter (5.4 mm) of the top of the intermediate extension. The inner most extension has a thickness of approximately 0.8 mm. As such, the inside diameter of the top of the inner most extension is approximately 2.4 mm. In an exemplary embodiment, the inner most extension has a length of approximately 100 mm. The inner most extension is illustrated as being hollow, but may be solid and include an aperture at the top to receive the end piece, as described below.

The inner most extension nests within the intermediate extension, which nest within the outer most extension positioned within the base, when the baton is not in use. Because the bottom of each extension has an outside diameter that is greater than the inside diameter of the top of the next adjacent extension positioned radially outward, the extensions may be telescopically extended to form an elongated baton, wherein the bottom of the intermediate extension frictionally secures with the top of the outer most extension, and the bottom of the inner most extension frictionally secures within the top of the intermediate extension. It should be noted that although the present invention is described with respect to having three extensions, in other embodiments, the present invention may have any number of extensions.

A base end is configured to be secured to the top of the base. The base end may be welded to the top of the base or attached using other suitable means, i.e. an adhesive or screwed into the top of the base. The base end has a height of approximately 20 mm extending between to open ends. When the base end is attached it protrudes approximately 10 mm past the end of the base but is substantially equal in height to the extensions when they are contracted inside the baton. A sidewall having an approximately 15 mm outer diameter forms a cavity through the base end and tapers inward from the bottom end to the top end of the base end. A bottom end of the base end is secured to the base and has an opening with a diameter of approximately 11.8 mm. Accordingly, the sidewall of the base end at the bottom end is approximately 3.2 mm thick. A top end of the base end had an opening with a diameter of approximately 11.4 mm. Accordingly, the sidewall of the base end at the top end is approximately 3.6 mm thick.

The outside diameter of the bottom of the outer most extension (12 mm) is greater than the diameter of the openings at the top end and the bottom end of the base end. However, the outside diameter of the top of the outer most extension (10 mm) is less than the diameter of the openings at the top end and the bottom end of the base end. Accordingly, the outer most extension is capable of extending partially through the openings in the base end. As the bottom of the outer most extension reaches the base end, the larger diameter of the outer most extension causes the outer most extension to engage the sidewall of the base end and become frictionally secured thereto. As such, each of the extensions can telescopically extend through the openings in the base end to form an elongated baton.

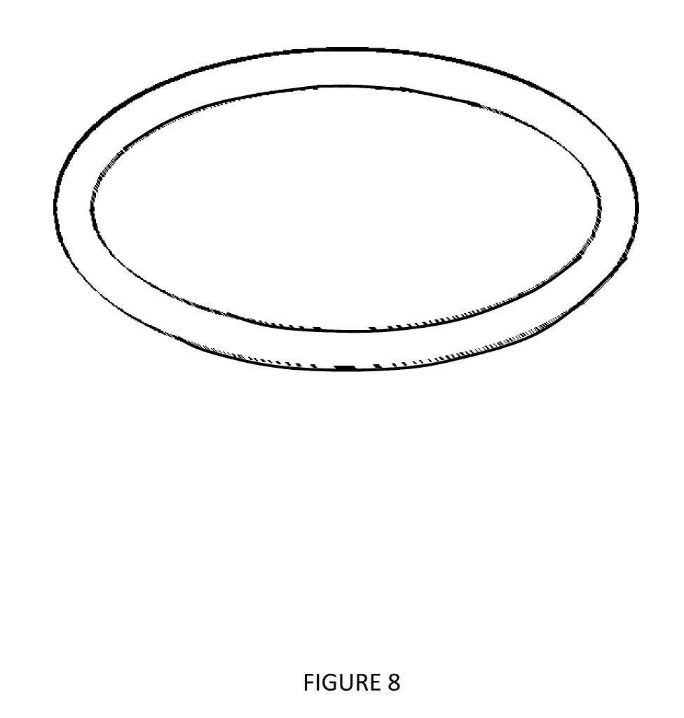

The cap of the baton is configured to secure around the base end. Accordingly, O-rings, as illustrated in FIG. 8, are positioned around the base end to frictionally secure the cap to the base end. In an exemplary embodiment, the O-rings are formed from a rubber material, but may be fabricated from any other suitable material capable of creating a friction fit. Annular indentations are formed in the outer sidewall of the base end to receive the O-rings therein. The illustrated embodiment is configured for two O-rings; however any number of O-rings may be used with the present invention. Alternatively, the base end may be fabricated with other friction inducing mechanisms, for example, annular rings that snap into grooves formed on an inner surface of the cap.

The top annular indentation is formed approximately 2.5 mm from the top end of the base and extends to approximately 3.6 mm from the top end of the base, thereby giving the annular indentation a height of 1.1 mm. The top annular indentation extends approximately 0.7 mm into the sidewall and has rounded corners with a radius of approximately 0.25 mm. The bottom annular indentation is formed approximately 7.5 mm from the top end of the base end and extends to approximately 8.6 mm from the top end of the base end, thereby giving the annular indentation a height of 1.1 mm. The bottom annular indentation extends approximately 0.7 mm into the sidewall and has rounded corners with a radius of approximately 0.25 mm. It should be appreciated that the number, size, and position of the annular indentations may be changed to customize or optimize a frictional hold between the cap and the base end.

It should also be appreciated that the baton may be formed with a base end that is secured within the top of the base. Particularly, the base end may be positioned in the top of the cavity of the base. In such an embodiment, the base end would still utilize the tapered sidewalls to secure the outer most extension when the baton is extended. Additionally, in such an embodiment, the cap could be configured to position on the top of the base.

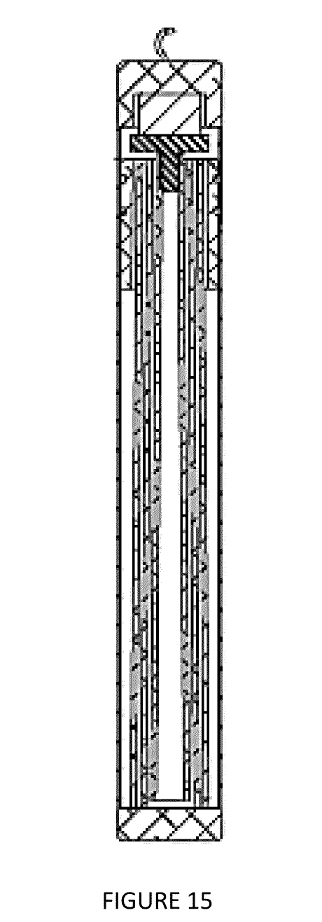

An end piece is secured to the top of the inner most extension. When the baton is fully assembled, as shown in FIG. 15, the extensions are positioned within the cavities of the base and the base end. The end piece is positioned outside of the base end cavity. In particular, the base end includes a disc having a diameter that is greater than the diameter of the opening at the top end of the base end. A post extends from the center of the disc into the cavity of the base end. The post is secured to the top of the inner most extension. The post may be welded, screwed, adhesively adhered, or otherwise joined to the inner most extension. As such, the top of the inner most extension is positioned at the top of the base end and connected to the end piece so that the disc of the end piece rests upon the top end of the base end. If the end piece is pulled away from the base end, the inner most extension is pulled through the opening in the base end, thereby causing each of the intermediate extension and the outer most extension to be pulled through the opening in the base end. The bottom of the outer most extension then engages the base end and prohibits the extensions from being pulled outward any further.

The cap has a height of approximately 25 mm and an outer diameter of approximately 16 mm. A lower cavity is formed at the bottom of the cap and has an opening at the bottom of the cap. The lower cavity has a height of approximately 15 mm and an inner diameter of approximately 15.2 mm. The lower cavity is configured to receive the base end of the baton. When the base end of the baton is inserted into the lower cavity, the O-rings of the base end frictionally engage the inner surface of the cap sidewall. An upper cavity extends from and is open to the lower cavity. The upper cavity has a height of approximately 5 mm from the end of the lower cavity. Accordingly, the distance from the opening of the lower cavity to the end of the upper cavity is approximately 20 mm. The upper cavity has a diameter of approximately 11 mm and is centered with respect to the lower cavity.

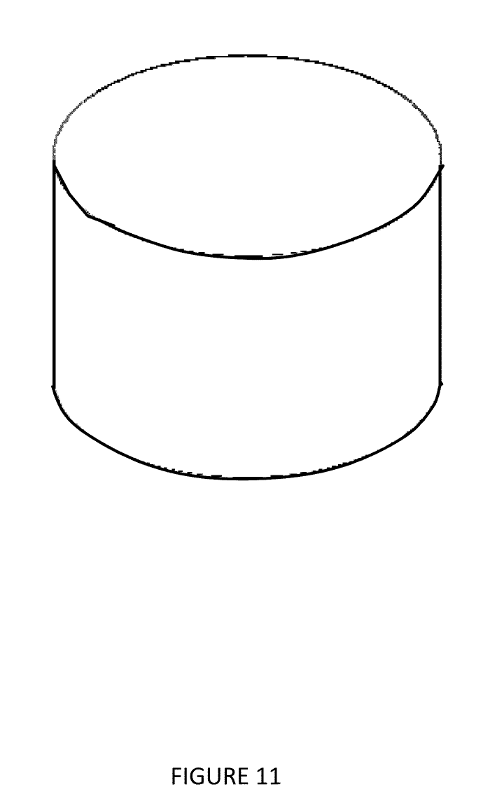

The upper cavity retains a magnet, as illustrated in FIG. 11. The magnet may be welded, adhesively adhered, or otherwise secured to the top of the upper cavity. When the cap is positioned on the base end, the magnet magnetically attaches to the end piece so that the end piece is removably attached to the cap. As such, the inner most extension is removably attached to the cap through the end piece and the magnet. The cap also includes apertures extending through the top thereof. The apertures are configured to receive a hook that attaches the baton to the chain. In one embodiment, the hook may be attached to the cap via welding.

To use the baton for self-defense, the base is pulled away from the cap, which is secured to the user's neck via the chain. As the base is pulled, the magnet in the cap pulls the end piece in the base, thereby pulling the inner most extension outward from the base. As the base is continued to be pulled, all of the extensions extend outward from the base to form the elongated baton. When the outer most extension secures to the base end, the force on the base overcomes the magnetic pull between the magnet and the end piece so that the elongated baton detaches entirely from the cap. The elongated baton may then be used to strike an attacker. Additionally, the chain may be broken away from the user's neck and used to slow the attacker.

After using the baton, the cap is positioned back on the end of the inner most extension so that the magnet attaches to the end piece on the inner most extension. By pushing the cap toward the base, the extensions retract into the base so that the cap can be attached to the base end and the jewelry may be worn as a decorative accessory.

The embodiments were chosen and described to best explain the principles of the invention and its practical application to persons who are skilled in the art. As various modifications could be made to the exemplary embodiments, as described above with reference to the corresponding illustrations, without departing from the scope of the invention, it is intended that all matter contained in the foregoing description and shown in the accompanying drawings shall be interpreted as illustrative rather than limiting. Thus, the breadth and scope of the present invention should not be limited by any of the above-described exemplary embodiments, but should be defined only in accordance with the following claims appended hereto and their equivalents.

What is claimed is:

1. A baton for use with a piece of jewelry comprising:
a cap attached to the piece of jewelry;
a base joined to the cap; and
a plurality of extensions positioned within the base and nested within one another, an inner most extension being removably joined to the cap so that when the base is removed from the cap the plurality of extensions telescopically extend from the base.

2. The baton of claim 1, wherein the inner most extension detaches from the cap when the plurality of extensions are fully extended.

3. The baton of claim 1, wherein the inner most extension is removably joined to the cap by a magnet.

4. The baton of claim 1, wherein each extension tapers inward from a bottom to a top.

5. The baton of claim 4, wherein a bottom of each extension has an outside diameter that is greater than an inside diameter of the top of the next adjacent extension positioned radially outward.

6. The baton of claim 1 further comprising a base end joined to a top of the base, the base end having an opening with a diameter that is less than a diameter of the bottom of the outer most extension, the plurality of extensions extending through the base end when the plurality of extensions are extended.

7. The baton of claim 1 further comprising an end piece secured to a top of the inner most extension, the end piece being removably joined to the cap.

8. The baton of claim 7, wherein the end piece is removably joined to a magnet positioned within the cap.

9. A baton for use with a piece of jewelry comprising:
a cap attached to the piece of jewelry; and
a plurality of extensions nested within one another, wherein an inner most extension is removably joined to the cap so that cap secures the inner most extension while the plurality of extensions telescopically extend when pulled away from the cap, the inner most extension detaching from the cap when the plurality of extensions are fully extended.

10. The baton of claim 9, wherein the inner most extension is removably joined to the cap by a magnet.

11. The baton of claim 9, wherein each extension tapers inward from a bottom to a top.

12. The baton of claim 11, wherein a bottom of each extension has an outside diameter that is greater than an inside diameter of the top of the next adjacent extension positioned radially outward.

13. The baton of claim 9 further comprising an end piece secured to a top of the inner most extension, the end piece being removably joined to the cap.

14. The baton of claim 9, wherein the end piece is removably joined to a magnet positioned within the cap.

15. A piece of jewelry comprising:
a chain;
a cap attached to the chain;
a base joined to the cap; and
a plurality of extensions positioned within the base and nested within one another, an inner most extension being removably joined to the cap so that cap secures the inner most extension while the plurality of extensions telescopically extend when pulled away from the cap, the inner most extension detaching from the cap when the plurality of extensions are fully extended.

16. The piece of jewelry of claim 15, wherein the inner most extension is removably joined to the cap by a magnet.

17. The piece of jewelry of claim 15, wherein each extension tapers inward from a bottom to a top.

18. The piece of jewelry of claim 17, wherein a bottom of each extension has an outside diameter that is greater than an inside diameter of the top of the next adjacent extension positioned radially outward.

19. The piece of jewelry of claim 15 further comprising an end piece secured to a top of the inner most extension.

20. The piece of jewelry of claim 19, wherein the end piece is removably joined to a magnet positioned within the cap.
